(19) United States
(12) Patent Application Publication
(10) Pub. No.: US 2012/0118760 A1
(43) Pub. Date: May 17, 2012

(54) WATER TREATMENT SYSTEM

(76) Inventor: Chester J. Sohn, Gig Harbor, WA (US)

(21) Appl. No.: 13/265,317

(22) PCT Filed: Apr. 21, 2010
(86) PCT No.: PCT/US10/31946

§ 371 Date: Feb. 3, 2012

Related U.S. Application Data
(60) Provisional application No. 61/171,351, filed on Apr. 21, 2009.
(60) Provisional application No. 61/177,653, filed on May 13, 2009.

(51) Int. Cl. C02F 1/461; C25B 9/18; C25B 9/00

(52) U.S. Cl. 205/742; 204/275.1; 204/273; 204/269

(57) ABSTRACT

A system carried by a watercraft for reducing the population of microorganisms in a body of water, including an electrolytic apparatus for producing antimicrobial chlorine-containing compounds and conduits for discharging electrolyzed water into the body of water.

### BACKGROUND

An algal bloom or “red tide” is a phenomenon in which the population of phytoplankton in a body of water rapidly increases. Such blooms are caused by an increase in the water of nutrients that these microorganisms need. Nutrient sources can include fertilizer from lawns and farms as well as other by-products of human activity, which reach open bodies of water through runoff or through direct discharge. Harmful algal blooms are associated with the production of natural toxins, the depletion of dissolved oxygen in water, and other harmful impacts.

A number of different methods have been used to control algal blooms in open bodies of water such as lakes, reservoirs, estuaries, and oceans. Some approaches seek to reduce the amount of nutrients in the water. For example, aluminum sulfate has been added to lakes in order to reduce the amount of phosphorus in the water and thereby reduce the amount of nutrients available to algae. Chemical inhibitors of microbial proliferation have also been added to water in order to treat algal blooms. Other approaches include the addition of agents such as ozone to kill algae in the water. There remains a need, however, for improved ways of treating algal blooms.

### DRAWINGS

FIG. 1A is a schematic sectional view showing an electrolytic water treatment apparatus and a centripetal expansion tank used in one embodiment of the present open water treatment system.

FIG. 1B is a sectional view of the centripetal expansion tank of FIG. 1A along line 1-1 of FIG. 1A.

FIG. 2 is a sectional view showing another electrolytic water treatment apparatus which uses an oxygen cathode.

FIG. 3 is a sectional view of an oxygen cathode.

FIG. 4 is a top plan view of one embodiment of the present open water treatment system.

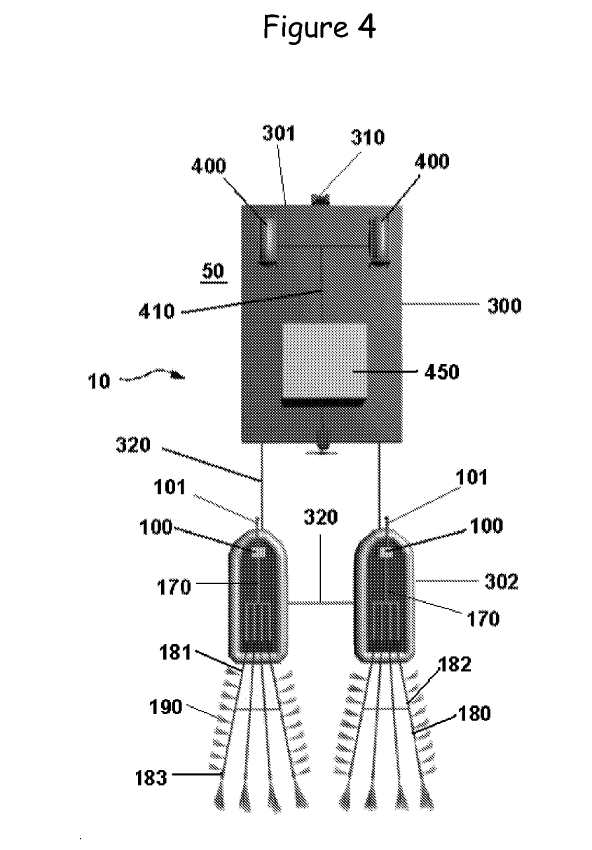

### SUMMARY

The present invention comprises a system carried by a watercraft, such as a boat, for reducing a population of microorganisms in a body of water. The system comprises:
an electrolytic apparatus comprising an inlet and an outlet, wherein the electrolytic apparatus is supported on the body of water by the watercraft;
a power supply in electrical communication with the electrolytic apparatus for providing power to the electrolytic apparatus;
a water supply conduit connected to the inlet of the electrolytic apparatus for providing water to the electrolytic apparatus; and
an exit conduit connected at a proximal end to the outlet of the electrolytic apparatus for conducting electrolyzed water from the electrolytic apparatus to the body of water.

In one embodiment, the exit conduit can comprise a plurality of openings through which untreated water can enter the exit conduit when such openings are in contact with the open water, thereby diluting the electrolyzed water. The exit conduit can also comprise a mixing chamber positioned distally of the outlet of the electrolytic apparatus, the mixing chamber comprising an inlet for receiving water from the body of water in order to dilute the electrolyzed water and an outlet for conducting diluted electrolyzed water to the body of water. Alternatively or in addition, the system can include one or more scoops facing opposite the direction of water flowing past the watercraft, wherein the scoops impel untreated water into the interior of the exit conduit. The electrolyzed water is preferably diluted by at least ten times, and more preferably by between 100 and 200 times before being discharged into a body of untreated water. The proximal end of the exit conduit can be pivoted in order to adjust the depth of the distal end of the exit conduit.

Preferably, the watercraft floats on the body of water and supports the electrolytic apparatus above the surface of the body of water. The power supply preferably comprises one or more generators carried on the watercraft, and the system can also include a plurality of electrolytic apparatuses. In one embodiment, the one or more generators are carried by a primary watercraft and the electrolytic apparatus is carried on an ancillary watercraft mechanically connected to the primary watercraft.

### DESCRIPTION

There remains a need for improved methods and systems for controlling algal blooms and otherwise reducing the amount of unwanted microorganisms, such as phytoplankton and bacteria, in bodies of water. The present system for water treatment comprises one or more watercraft which carry an electrolytic apparatus for producing chlorine-containing antimicrobial compounds such as hypochlorous acid from water. Such compounds are generally diluted and then dispersed through conduits into an open body of water in order to reduce the microorganism population in the water.

### Definitions

As used herein, the following terms and variations thereof have the meanings given below, unless a different meaning is clearly intended by the context in which such term is used.

“Algae” and “phytoplankton” both refer to small or microscopic photosynthetic organisms that float or drift, sometimes in great numbers, in fresh or salt water near the surface.

“Microorganism” refers to an organism that is too small to be seen by the unaided eye, especially a single-celled organism, such as a bacterium. Microorganisms include algae and phytoplankton, although such organisms may aggregate in numbers visible to the unaided human eye.

“Open water” refers to an area with standing or flowing water. Open water includes fresh, estuarine, and marine (salt) water, as found for example in lakes, reservoirs, estuaries, and oceans.

“Watercraft” refers to a vessel or vessels which carry the components of the present water treatment system on a body of open water, and can be surface vessels or submersible. Such watercraft can include motors and/or other means for propulsion, or alternatively can be without such means for propulsion, such as a barge. The components of the present water treatment system can be carried by a single watercraft or, in some embodiments, can be carried by a plurality of tethered or otherwise associated watercraft.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Electrolytic Apparatus

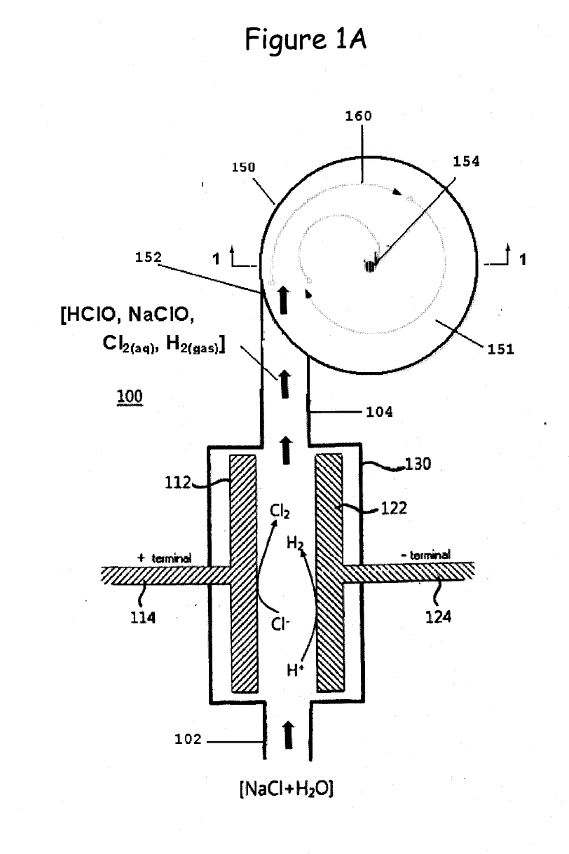

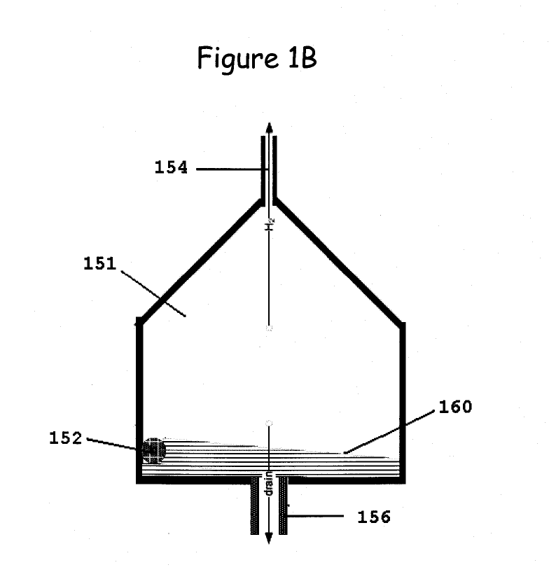

FIG. 1A is a schematic sectional view showing an electrolytic apparatus for use with the present water treatment system. This electrolytic apparatus 100 comprises an electrolytic chamber 130 including an anode 112 and a cathode 122. Water, for example from a body of water on which the present system operates, enters the electrolytic chamber 130 via inlet 102 and flows between the anode 112 and cathode 122 in order to produce electrolyzed water. The anode 112 is connected to a positive (+) terminal 114 which is connected to a positive (+) pole of a direct-current power source (not shown), and the cathode 122 is connected to a negative (−) terminal 124 which is connected to a negative (−) pole of the direct-current power source.

When electric power is supplied between the positive (+) terminal 114 and negative (−) terminal 124, an oxidation reaction (Reaction Formula 1) of chlorine ions included in the water arises at the anode 112, and a reduction reaction (Reaction Formula 2) of hydrogen ions arises at the cathode 122.

(Anode) 2Cr-+Ch+2e-[standard hydrogen electrode (SHE) potential: 1.36 V] Reaction Formula 1

(Cathode) 2H++2e-+H2 [standard hydrogen electrode (SHE) potential: 0.0 V] Reaction Formula 2

In this case, the electromotive force (standard hydrogen electrode (SHE) potential) of the oxidation reaction of chlorine ions arising in the anode 112 is 1.36 V, and the electromotive force (standard hydrogen electrode (SHE) potential) of the reduction reaction of hydrogen ions arising in the cathode 122 is 0.0 V, and thus the potential difference in the oxidation-reduction reaction of the conventional electrolytic apparatus is 1.36 V.

Further, chlorine, which is produced by the oxidation reaction of chlorine ions at the anode 112, is converted into hypochlorous acid (HClO), which has germicidal power, when the chlorine generated at the anode reacts with water as represented by the following Reaction Formula 3. The chlorine generated pursuant to Reaction Formula 1 can exist as or be converted into hypochlorous acid (HClO), chlorine (Ch), sodium hypochlorite (NaCIO) and/or other compounds depending on the acidity (pH) of the water.

(Anode) H20+Ch˜HCIO+H++cr Reaction Formula 3

Therefore, when water is electrolyzed in the electrolytic apparatus 100, hypochlorous acid (HCIO), chlorine (Ch), sodium hypochlorite (NaCIO) and other chlorine-containing antimicrobial compounds are produced. When the water entering the inlet 102 is fresh water or water otherwise of salinity less than that generally found in seawater (3.5%), an additional source of sodium chloride can be provided in order to raise the salinity of the water in the electrolytic chamber 130, in order to facilitate production of such chlorine-containing antimicrobial compounds. For example, a brine solution can be introduced into such water, either before it enters the electrolytic chamber 130 or via direct admixture within the chamber, in order to raise the salinity of water in the electrolytic chamber 130.

As can be seen in Reaction Formula 2 above, in addition to the foregoing reaction products, hydrogen is produced as a by-product. The hydrogen (H2 gas) produced in the reaction represented by Reaction Formula 2 remains initially entrained in the water flowing past the anode 112 and cathode 122. In some embodiments, the electrolyzed water can be directly discharged into an open body of water 50, where the entrained hydrogen will diffuse into the atmosphere.

In some embodiments it may be preferable to remove the hydrogen gas for safety reasons, so that it does not cause an explosion. As shown in FIG. 1A, water exiting the outlet 104 of the electrolytic chamber 130 and carrying entrained hydrogen gas can be directed to a centripetal expansion tank 150 in fluid communication with the outlet 104 of the electrolytic chamber 130. The water (160, whose flow is shown with directional arrows in FIG. 1A) enters the centripetal expansion tank 150 through inlet 152. The water exiting the outlet 104 and entering the centripetal expansion tank 150 experiences a pressure drop, such as by passing from a smaller volume pipe into a larger volume pipe or area within the centripetal expansion tank 150. For example, the water can pass from a 4 inch pipe into a 10 inch pipe. The pressure of the interior 151 of the centripetal expansion tank 150 is thus lower than that of the interior of the electrolytic chamber 130, so that entrained hydrogen gas will tend to be released from the water after entering the centripetal expansion tank 150. The interior 151 of the centripetal expansion tank 150 also directs the water in the tank in a circular (centrifugal) fashion around the interior periphery of the centripetal expansion tank 150, for example by having interior walls having a cylindrical configuration, which further serves to assist in the release of entrained hydrogen gas.

The centripetal expansion tank 150 further includes a drain opening 156, preferably at a central, lower end of the centripetal expansion tank 150 for draining water received from the electrolytic chamber 130. A vent opening 154 in an upper end of the centripetal expansion tank 150 is also provided for receiving and removing hydrogen gas released within the centripetal expansion tank 150. The vent opening 154 can be in communication with a storage tank or container for storing the hydrogen gas, which can be captured and stored in ways known to the art.

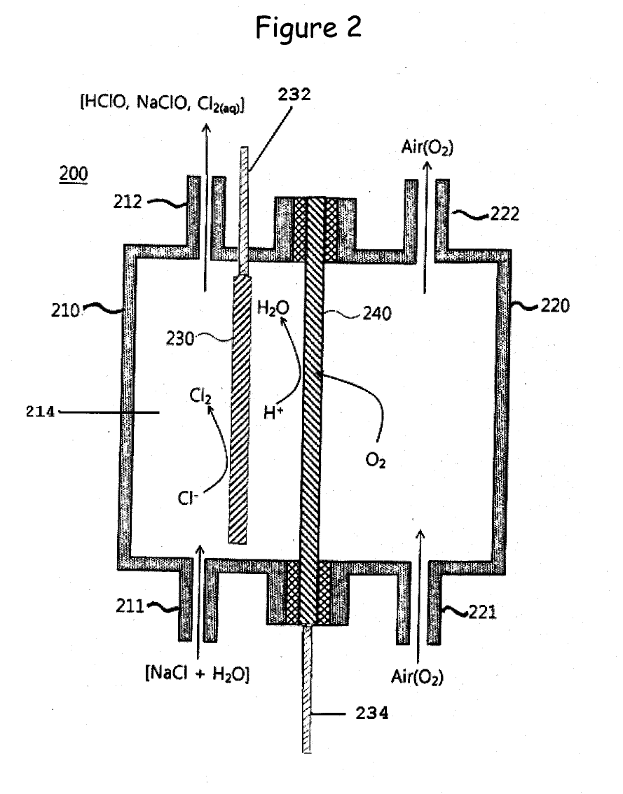

FIG. 2 is a sectional view showing another water electrolytic apparatus 200 using an oxygen cathode 240. The water electrolytic apparatus 200, which is an electrolytic apparatus without a diaphragm, includes a water electrolytic chamber 210 into which water is introduced, and an oxygen supply chamber 220 into which oxygen (usually present in admixture with other gases such as air) is introduced. The water electrolytic chamber 210 includes an anode 230 for producing chlorine oxides by electrolyzing water and an oxygen cathode 240 for separating the water electrolytic chamber 210 and the oxygen supply chamber 220 and producing water by reacting hydrogen ions in the water electrolytic chamber 210 with oxygen introduced into the oxygen supply chamber 220. The water electrolytic chamber 210 is provided with a water inlet pipe 211 and a water outlet pipe 212, and the oxygen supply chamber 220 is provided with an oxygen inlet pipe 221 and an oxygen outlet pipe 222. As seen in FIG. 2, the anode 230 extends into an interior portion 214 of the electrolytic chamber 210 and is connected to a positive terminal 232 attached to a wall of the electrolytic chamber 210. The cathode electrode 240 is connected to a negative terminal 234.

The water flowing into the water electrolytic chamber 210 through the water inlet pipe 211 passes through the space between the anode 230 and the oxygen cathode 240 and is then discharged to the outside through the water outlet pipe 212. The air including oxygen is introduced into the oxygen supply chamber 220, which is opposite to the water electrolytic chamber 210 based on the oxygen cathode 240, through the oxygen inlet pipe 221, and the air including unreacted oxygen which has not bonded with hydrogen ions on the oxygen cathode is discharged to the outside through the oxygen outlet pipe 222. When electricity is supplied between the anode 230 and the oxygen cathode 240, an oxidation reaction, represented by the following Reaction Formula 4, arises at the anode 230, and a reduction reaction, represented by the following Reaction Formula 5, arises at the oxygen cathode 240.

(Anode) 2Cr-+Ch+2e-[standard hydrogen electrode (SHE) potential: 1.36V] Reaction Formula 4

(Cathode) H++O2+4e-+40K [standard hydrogen electrode (SHE) potential: 0.4V] Reaction Formula 5

Here, the reduction reaction arising at the oxygen cathode 240 is a reaction in which hydrogen ions and oxygen react with each other to produce hydroxide ions or water. At this time, the standard hydrogen electrode (SHE) potential is about 0.401 V.

In the electrolytic apparatus 200, the minimum electromotive force necessary for the above Reaction Formula 4 and Reaction Formula 5 is 0.9 V, which is the difference in standard hydrogen electrode (SHE) potential between the Reaction Formula 4 and Reaction Formula 5. Therefore, a theoretic voltage drop of about 0.4 V occurs compared to a conventional electrolytic apparatus, thus decreasing energy consumption. The supply voltage applied between the anode 230 and the oxygen cathode 240 according to the present invention is preferably between 3 and 5 volts, and more preferably between

3.5 and 4 volts, and a current density of 1.5 kA/m2 is supplied. That is, according to the present invention, it can be seen that the electric energy necessary for producing chlorine oxides can be decreased by about 30% compared to conventional technologies.

The chlorine produced on the anode 230 reacts with water (refer to Reaction Formula 3) to produce hypochlorous acid. As described above, the produced hypochlorous acid is converted into hypochlorous acid, chlorine, sodium hypochlorite and the like depending on the pH of water. The water electrolytic apparatus according to the present invention preferably produces only chlorine oxides such as hypochlorous acid, chlorine, and sodium hypochlorite, and does not produce by-products such as hydrogen.

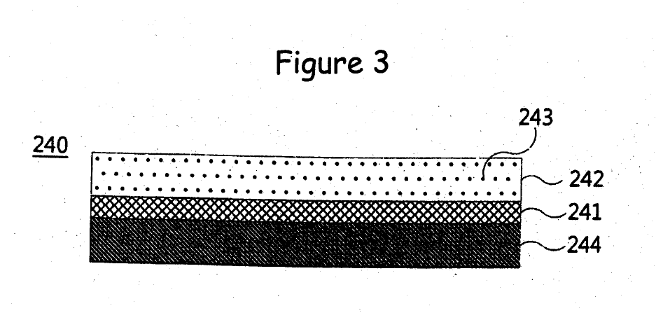

FIG. 3 is a sectional view of an oxygen cathode for use with the electrolytic apparatus of FIG. 2. This oxygen cathode includes a conductive support 241 which separates the water electrolytic chamber 210 and the oxygen supply chamber 220 and to which electric current is supplied, a reaction layer 242 which is formed on one side of the conductive support 241 facing the water electrolytic chamber 210 and which brings the hydrogen ions in the water electrolytic chamber 210 into contact with the oxygen in the oxygen supply chamber 220. The oxygen cathode further comprises a catalyst 243 which is included in the reaction layer 242 and which accelerates the reaction in which hydrogen ions and oxygen are reacted with each other to produce water, as well as a hydrophobic gas diffusion layer 244 which is formed on the other side of the conductive support 241 facing the oxygen supply chamber 220 and which diffuses the oxygen introduced into the oxygen supply chamber 220.

The conductive support 241, which is preferably composed of a mesh and an expanded metal, can be made of anyone selected from among silver, silver-plated metals (for example, silver-plated stainless steel, silver-plated nickel, and silver-plated copper), gold, gold-plated metals (for example, cold-plated nickel, and gold-plated copper), nickel, cobalt, cobalt-plated metals (for example, cobalt-plated copper), and mixtures thereof. More preferably, the conductive support 241 can be made from silver or silverplated metals.

The hydrophobic gas diffusion layer 244 can be made of anyone selected from among silver, silver-plated metals such as silver-plated nickel, hydrocarbon polymers such as vinyl resin, polyethylene and polypropylene, polytetrafluoroethylene (PTFE), fluoro-ethylene-propylene (FEP) copolymers, polyfluoroethylene and mixtures thereof. Preferably, the hydrophobic gas diffusion layer 244 can be selected from among fluoropolymers such as polytetrafluoroethylene (PTFE) and halocarbon polymers including chlorine and/or fluorine. These polymers have a molecular weight of 10,000 g/mol or more. The gas diffusion layer is porous and is preferably formed from a fine mesh in order to allow oxygen (air) under pressure to flow through the mesh and react with H2 produced in the electrolytic chamber 210 and form H20, effectively removing the H2 from the electrolytic chamber 210.

The reaction layer 242 includes at least one catalyst 243 in order to accelerate the reaction of oxygen and hydrogen. The catalyst 243 included in the reaction layer 242 can be made of anyone selected from among silver, platinum, platinum-group metals, and mixtures thereof. More preferably, the catalyst 243 can be selected from among silver, platinum, and a mixture thereof. The amount of the catalyst 243 is determined by reaction efficiency and economical aspects. When the catalyst is directly used, it is preferred that the catalyst be loaded at an amount of 0.5-10 g/m2 and when the catalyst is applied on a support material (such as carbon black) and then used, it is preferred that the catalyst be loaded at an amount of 1.5-4 g/m².

Further, the reaction layer 242 can be made of anyone selected from among polytetrafluoroethylene (PTFE), fluoro-ethylene-propylene (FEP) copolymers, fluoropolymers (Nafion™: fluorocarbon sulfuric acid resin, and derivatives thereof), and halocarbon polymers (polychlorofluoroethylene and mixtures thereof). More preferably, the reaction layer 242 can be selected from among polytetrafluoroethylene (PTFE), Nafion™, and mixtures or derivatives thereof.

### Water Treatment System

The present water treatment system 10 is illustrated in FIG. 5. The water treatment system 10 comprises a watercraft 300, which in the illustrated embodiment is a self-propelled watercraft. Alternatively, the watercraft 300 can be towed by another vessel to locations in need of water treatment in the manner of a barge, such as using tug attachment 310.

The water treatment system 10 further comprises a power source which supplies power to one or more electrolytic apparatuses 100 associated with the watercraft 300. In the illustrated embodiment of FIG. 5, the power source is a set of generators 400, which supplies power via electrical conduits 410 to each of the electrolytic apparatuses 100 and to the motor 450 of the watercraft 300. In the embodiment of FIG. 5, the power source is located on a different watercraft than the electrolytic apparatuses 100, which are carried on ancillary watercraft 302 towed by the main watercraft 301. When the one or more generators 400 and one or more electrolytic apparatuses 100 are located on separate vessels in this way, such vessels are preferably physically connected by a tether 320, such as a rope or chain, or by another means for securing the vessels to one another. Separate generators 400 can also be provided for each of the electrolytic apparatuses 100, depending on the power needs of the electrolytic apparatuses 100 and size of the watercraft 300 or 302 carrying them. Alternatively, the generators 400 can be located on the same watercraft, or even on shore (in small bodies of water).

In the present system, a plurality of electrolytic apparatuses 100 is preferably used, as illustrated in FIG. 5, although a single electrolytic apparatus 100 can be employed instead. When a greater quantity of chlorine-containing antimicrobial compounds is needed for a particular application, additional electrolytic apparatuses 100 can be mounted to the watercraft 300 and/or 302, as long as sufficient space and power is available to operate them. Water from a source of open water 50 on which the watercraft 300 is placed is conducted into each of the electrolytic apparatuses 100 in ways known to the art, such as by pumping the water 50 through a pipe 101 or other conduit leading into the inlet 102 of the electrolytic apparatus 100. If necessary, such water can be filtered prior to being electrolyzed. After electrolyzing the water 50 as described above, the electrolyzed water is conducted out of the drain opening 156 or other fluid outlet of the electrolytic apparatus 100 and into a conduit, such as feeder pipe 170 in the embodiment of FIG. 5. From feeder pipe 170 the electrolyzed water is conducted into an exit conduit 180 projecting rearwardly from the back end of the watercraft 302 (or from the back end of the watercraft 301, in embodiments in which the electrolytic apparatuses 100 are on the main watercraft 301), and electrolyzed water is ultimately dispensed into the body of water 50.

Before reaching the open water 50, the electrolyzed water is preferably diluted. This is because the concentration of chloride-containing compounds such as HOCI in the electrolyzed water may be higher than necessary or desirable for reducing the population of microorganisms such as phytoplankton. Typically, the concentration of HOCI in the electrolyzed water is on the order of 2000 parts per million, and at such concentrations it is desirable to dilute the electrolyzed water by at least ten times, and more preferably by between 100 and 200 times. Dilution of the electrolyzed water can be accomplished by conducting a stream of untreated water into the exit conduit upstream of the distal end 183 through which some or all of the treated water 190 exits the exit conduit 180. In the embodiment of FIG. 5, however, dilution is conducted passively by providing openings 182 through which untreated water can enter the exit conduit 180 when such openings are in contact with the open water 50, as well as through which treated water 190 can leave the exit conduit 180. When no dilution of the treated water 190 is desired, the one or more openings 182 can be maintained above the surface of the open water 50, or can be discharged under pressure so that substantially no untreated water enters the exit conduits 180.

As treated water within the conduit 180 travels from the proximal end of the conduit 180 to the outlet at the distal end, it will become progressively diluted by untreated water entering the conduit 180 through the openings 182. Further dilution can be accomplished by providing one or more scoops facing toward the front of the watercraft 300, i.e. opposite the direction of water flowing past the watercraft 300, so that untreated water is impelled into the interior of the exit conduit 180. Other means for diluting the treated water 190 known to the art can also be used.

Preferably, the depth of the distal end 183 of each of the exit conduits 180 can be adjusted, such as by pivoting the proximal end 181 of the exit conduit 180 about an axis so as to increase the angle, relative to the surface of the open water 50, at which the exit conduit 180 (which preferably extends longitudinally in a substantially straight manner) extends into the water 50. When reducing a population of phytoplankton or other organisms at the surface of an open body of water is desired, the distal ends 183 of the exit conduits 180 are maintained at or near the surface of the body of water. In this configuration, treated water 190 containing anti-microbial chlorine compounds is dispersed only at or near the surface of the water, so that the anti-microbial compounds are active primarily at the surface. When the treatment of microbes below the surface of the water, such as at the bottom of the body of water, is desired, the exit conduits 180 are preferably pivoted so that the distal ends 183 of the exit conduits 180 are directed downward, under the water's surface, to a desired depth. In this embodiment, the openings 182 are preferably clustered adjacent to the distal end 183 of the exit conduit 180 so that anti-microbial compounds are directed to the desired depth.

### Method of Use

In use, the water treatment system 10 is conducted to a body of open water in need of treatment with antimicrobial chlorine-containing compounds, such as one experiencing an algal bloom. The water treatment system lO is positioned in the body of water in need of treatment, and water from the water source 50 is conducted through one or more electrolytic apparatuses 100 in order to produce electrolyzed water containing antimicrobial chlorine-containing compounds. The electrolyzed water is then conducted to the exit conduits 180, where additional untreated water is preferably admixed with the electrolyzed water entering the exit conduits through one or more openings 182, when dilution of the electrolyzed water is desired. Electrolyzed water is then discharged into the source of water 50 through the openings 182 and/or through an outlet at the distal end 183 of each of the exit conduits 180.

The components of the present water treatment system described above can also, in an alternative embodiment, be employed in treating water in sewage treatment systems in order to reduce the microbial content of such water. The components of the system are in this case preferably supported on a structure in the sewage treatment facility, rather than on a watercraft, although watercraft-born embodiments can be used in sewage treatment ponds. In this embodiment, water from the sewage treatment facility to be treated enters the inlet 102 and is electrolyzed, thereby creating anti-microbial chlorinecontaining compounds in the water stream, which is then passed through the outlet 104 and through an exit conduit which conducts the treated water to the next stage of the sewage treatment process.

### EXAMPLES

### Example 1

### Fabrication of an Oxygen Cathode

An oxygen cathode was fabricated using a nickel mesh having a thickness of 0.1 mm as a conductive support. The fabrication process was as follows.
1. A silver powder solution including silver particles of 0.5˜1 μm was sprayed on a nickel mesh and then dried.
2. The dried nickel mesh sprayed with the silver powder solution was sintered in air at a temperature of 450° C. for 30 minutes.
3. An alcohol solution including dinitrodiamine platinum salt of 50 gPtli was applied on one side of an electrode substrate, and then the electrode substrate coated with the alcohol solution was baked at a temperature of 350° C. for 10 minutes to form a reaction layer coated with platinum.
4. A polytetrafluoroethylene (PTFE) solution was applied on the other side of a conductive support, and then heated to 300° C. in air to obtain a hydrophobic gas diffusion layer.

### Example 2

### Electrolysis with the Oxygen Cathode

An anode of a water electrolytic apparatus was fabricated by coating an expanded titanium mesh having a thickness of 1 mm with Ir/Ru/Ti oxide. The oxygen cathode fabricated through the process of Example 1 was supplied with electric current by bringing the oxygen cathode into contact with a nickel mesh. The distance between the oxygen cathode and the anode was 5 mm. The electrolytic apparatus was supplied with water, and the oxygen cathode was supplied with air. The current density of the electrolytic apparatus in operation was 1.5 kA/m2, and the electrolysis temperature thereof was 30° C. The average current efficiency (chlorine production efficiency) of the electrolytic apparatus was 75%, and hydrogen was not observed.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

1. A system carried by a watercraft for reducing a population of microorganisms in a body of water, comprising:
an electrolytic apparatus comprising an inlet and an outlet, wherein the electrolytic apparatus is supported on the body of water by the watercraft;
a power supply in electrical communication with the electrolytic apparatus for providing power to the electrolytic apparatus;
a water supply conduit connected to the inlet of the electrolytic apparatus for providing water to the electrolytic apparatus; and
an exit conduit connected at a proximal end to the outlet of the electrolytic apparatus for conducting electrolyzed water from the electrolytic apparatus to the body of water.

2. The system of claim 1, wherein the exit conduit comprises a plurality of openings through which untreated water can enter the exit conduit when such openings are in contact with the open water, thereby diluting the electrolyzed water.

3. The system of claim 1, wherein the proximal end of the exit conduit can be pivoted in order to adjust the depth of the distal end of the exit conduit.

4. The system of claim 1, wherein the exit conduit comprises a mixing chamber positioned distally of the outlet of the electrolytic apparatus, the mixing chamber comprising an inlet for receiving water from the body of water in order to dilute the electrolyzed water and an outlet for conducting diluted electrolyzed water to the body of water.

5. The system of claim 1, wherein the system further comprises or more scoops facing opposite the direction of water flowing past the watercraft, wherein the scoops impel untreated water into the interior of the exit conduit.

6. The system of claim 1, wherein the watercraft floats on the body of water and supports the electrolytic apparatus above the surface of the body of water.

7. The system of claim 1, wherein the power supply comprises a generator carried on the watercraft.

8. The system of claim 7, wherein the system comprises a plurality of generators.

9. The system of claim 1, wherein the generator is carried by a primary watercraft and the electrolytic apparatus is carried on an ancillary watercraft mechanically connected to the primary watercraft.

10. The system of claim 1, wherein the system comprises a plurality of electrolytic apparatuses.

11. The system of claim 1, further comprising a source of untreated water for diluting the electrolyzed water, wherein the water is diluted by at least ten times, and more preferably by between 100 and 200 times.

12. (canceled)

13. A method of reducing a population of microorganisms in a body of water, comprising:
providing the system of claim 1 on a watercraft in a body of open water in need of treatment with antimicrobial chlorine-containing compounds;
electrolyzing water from the body of open water with the electrolytic apparatus;
conducting electrolyzed water from the electrolytic apparatus to the body of open water through the exit conduits of the system.

14. The method of claim 13, wherein the electrolyzed water is diluted prior to being discharged into the body of open water.
